(19) United States
(12) Patent Application Publication
(10) Pub. No.: US 2026/0001780 A1
(43) Pub. Date: Jan. 1, 2026

(54) Biofilter Housing System for Well Water Purification

(71) Applicants: Miguel Jagessar, Couva (TT); Vishnu Armoogam, Tunapuna (TT); Mickel Rackal, Claxton Bay (TT)

(72) Inventors: Miguel Jagessar, Couva (TT); Vishnu Armoogam, Tunapuna (TT); Mickel Rackal, Claxton Bay (TT)

(73) Assignee: Miguel Jagessar, Couva (TT)

(21) Appl. No.: 18/759,849

(22) Filed: Jun. 29, 2024

(51) Int. Cl. C02F 1/00; C02F 1/28; C02F 103/06

(52) U.S. Cl. CPC C02F 1/001; C02F 1/283; C02F 2103/06; C02F 2201/004

(57) ABSTRACT

The present invention relates to a biofilter for removal of iron from well water, which comprises an enclosed spherical housing, with inlet and outlet nozzles for flow of water and an inlet nozzle with connecting elliptical cavity for aeration. The housing can be filled with activated carbon material. The housing increases contact time between contaminated water and biomaterial by directing the flow path. The biofilter can be used for either residential or commercial purposes. The spherical housing comprises an elliptical cavity for aeration, donut-shaped cavity for increasing contact time of water, and inner concave core with a plurality of inlet and outlet apertures for directing the flow path to allow for effective removal of iron as contaminated water flows under gravitational feed through the biomaterial for removal of contaminants, thereby producing potable water at the outlet of the housing. Exhausted biomaterial can be treated and reused or be entirely replaced.

### PRIOR ART

Water filtration devices declare improved contact time between fluid and filter media by trying to control the flow path. Patent IN202341055027 was designed to improve the contact time of fluid with the filter media. This invention utilizes a spiral blade attached to a shaft to create a spiral flow path within the cartridge to improve contact with the adsorbent.

U.S. Pat. No. 10,905,983 addresses a design for creating laminar flow within a filter through the use of helical ridges. The helical ridges are formed along the internal walls of the filter housing allowing water to flow against the external walls of the filter cartridge. The helical paths spiral along the length of the filter cartridge to create uniform flow along the filter.

US20030034289 includes an egg-shaped housing formed from a lower shell and an upper shell. The lower shell is divided into an intake chamber and an outflow chamber. A filter or membrane is placed between the upper and lower shells. The upper and lower chambers of the filter have a curved surface to aid in swirling motion of water through the filter.

US20030136724 utilizes a conical shaped chamber directed towards the activated carbon layer. US20070199880 designed for: 1.) control of flow of unfiltered and filtered water through the use of valves within the assembly, 2.) aerator assembly to introduce air into unfiltered water to increase area of coverage and wetting efficiency, 3.) flow diverters to direct unfiltered and filtered water within the filtration unit, and 4.) flow straightener at the tip of the outlet to create laminar flow out of the filter between 0.9 and 1.1 gpm inclusive.

CN112999731 relates to a multi-layer composite water purification filter element, which comprises a shell and four filter plates arranged in the shell side by side, wherein the four filter plates are respectively a first filter plate, a second filter plate, a third filter plate and a fourth filter plate, and the first filter plate, the fourth filter plate and the shell form a first water inlet channel. The multi-layer composite water purification filter element is provided with a plurality of water inlet channels, the four filter plates are used for simultaneously filtering, and the four filter plates are arranged side by side, so that the multi-layer composite water purification filter element is high in filtering efficiency, small in size and good in filtering effect.

### BACKGROUND OF THE INVENTION

The World Health Organization recommends Fe(II) concentration limits of 0.3 mg/L for potable water. The adsorption process has proved to remove iron and other heavy metal contaminants in well water. Using batch and continuous column experiments, it was found that adsorbents made from chemically or thermally activated biomaterials can be used to treat Fe(II) concentrations up to 150 mg/L. Contact time and adsorbent dosage directly affects quantity of Fe(II) removal from water during the adsorption process and is inversely proportional to adsorbent dose for removal of impurities. Activated carbon can be costly and should be optimally utilized during the adsorption process. A biofilter housing that optimizes iron removal and activated carbon usage is detailed in the description below.

The housing system improves adsorption by firstly producing water jet streams via small apertures, implementing aeration for oxidation of Fe(II) to Fe(III) via an inlet T-shaped nozzle that facilitates air entry and overflow of water due to backpressure. Secondly, the vertically axially oriented streams are perpendicularly re-directed radially through the upper concave core of the housing via a plurality of openings. The flow then takes a natural axial and circumferential path, due to gravitational feed, through the filter media as it passes through a donut-shaped cavity. This cavity allows for greater contact time between water and filter media. Finally, the flow is redirected radially inwardly through a plurality of apertures in the concave core and exits vertically axially through the outlet nozzle with an end cap containing fine holes for discharge of purified water only. This end cap can easily be removed for replacement of filter media.

### SUMMARY OF THE INVENTION

The biofilter housing system relates to well water treatment using carbon activated adsorbents. The unique spherical biofilter housing and inner core, which can be manufactured from plastic, metal, ceramic or clay can be filled with biomaterial and improves contact time for better removal of contaminants. The inlet nozzle allows for distribution of water jets through a plurality of holes. The water then enters an elliptical cavity from a 2D perspective, where air enters via an inlet nozzle for aeration. The air inlet nozzle is T-shaped and also allows for overflow due to backpressure. Water continues to flow by gravity through the inner concave core and exits through a plurality of openings at the top portion of the core. It then enters a donut-shaped cavity and flows circumferentially and vertically downwards through the biofilter media, allowing for sufficient contact time for removal of impurities. The flow is finally redirected to the inner core of the housing through a plurality of apertures and exits through fine holes at the outlet nozzle of the housing. The fine holes prevent the filter media from flowing through the outlet nozzle with the treated water.

### BRIEF DESCRIPTION OF DRAWINGS

FIG. 1 illustrates an isometric view of the biofilter system.

FIGS. 2, 3, and 4 illustrates the plan, sectional view 1-1, and front views of the biofilter housing unit.

FIGS. 5, 6, 7, and 8 illustrates sectional view 3-3, isometric and right views, and sectional view 2-2 of biofilter housing unit.

FIGS. 9, 10, 11, 12, 13, and 14 illustrates plan, isometric, front, and side views, and sectional view 4-4, and bottom view of biofilter housing cover.

FIGS. 15, 16, 17, and 18 illustrates the plan, isometric, and front views, and sectional view 5-5 of the biofilter main housing body.

### DETAILED DESCRIPTION OF THE INVENTION

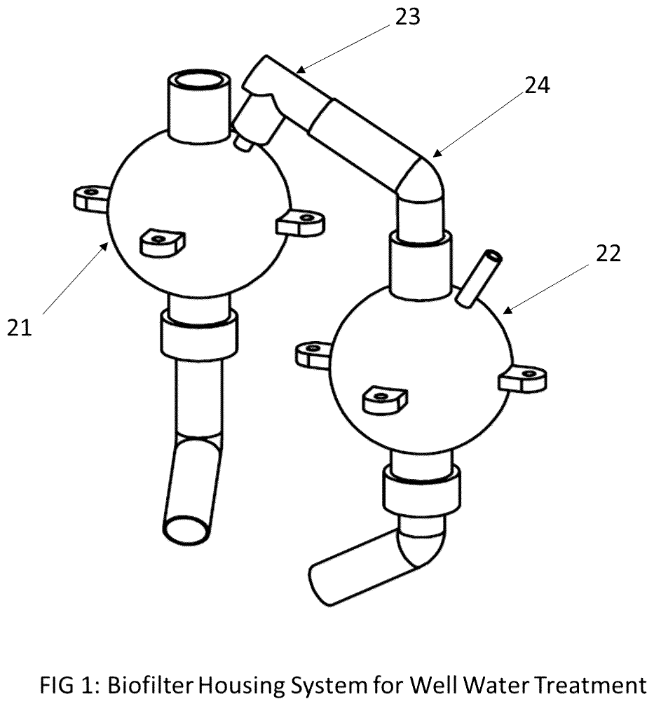

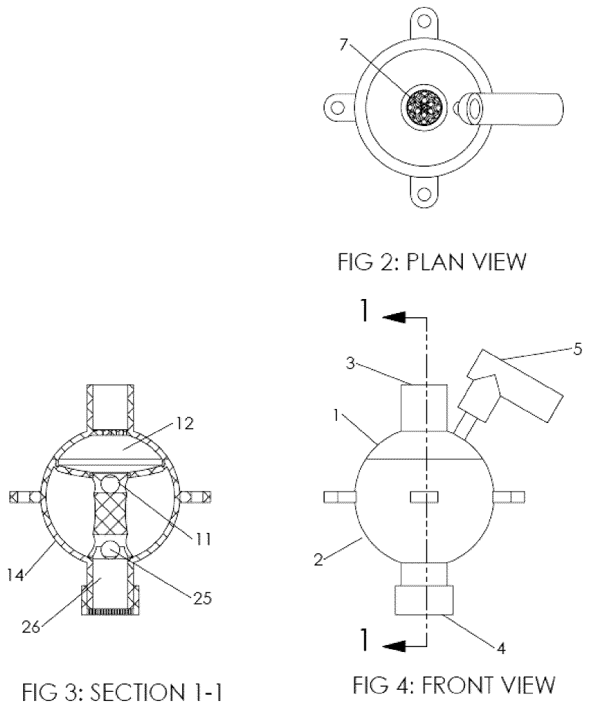

The biofilter housing system for iron removal from well water is illustrated in FIG. 1. It comprises of two similar spherical housing units which is illustrated in FIGS. 2, 3 and 4. The primary biofilter unit (21) is coupled to a secondary biofilter unit (22) via a T-nozzle (23) and elbow (24) as illustrated in FIG. 1. T-nozzle (23) allows for entry of air and overflow of water into the secondary unit (22). Contaminated water enters inlet nozzle (3) and potable water exits outlet nozzle (4) as illustrated in FIG. 4. As water enters the inlet nozzle (3) it passes through a plurality of fine holes (7), which is illustrated in FIG. 2. These fine holes (7) allow water jets to enter an elliptical cavity (12) which is illustrated in FIG. 3. The increased velocity of water due to the water jets reduces ambient pressure within the cavity (12) and draws air into it via the air inlet nozzle (6) which is depicted in FIG. 8. Fe(II) oxide is oxidized to Fe(III) oxide within the cavity (12). These larger ferric molecules can then be more readily removed as it passes through the absorbate.

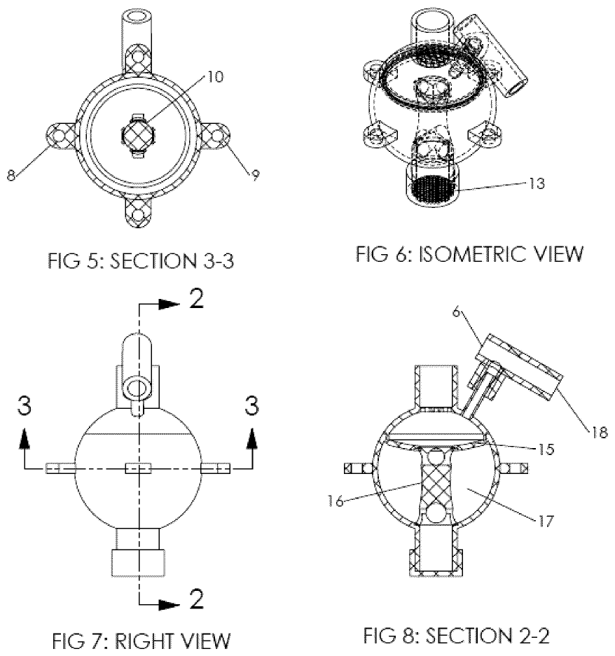

Water then converges into a cup-shaped pocket (10) as depicted in FIG. 5, which is inset within the central concave core (16) as depicted in FIG. 8. Flow then diverges horizontally, through a plurality of apertures (11) located at the top portion of the central concave core of the housing, as illustrated in FIG. 3. A concave saucer-shaped partition (15), illustrated in FIG. 8 prevents filter media from entering the aeration cavity (12). Untreated water then exits the apertures (11) and enters the donut-shaped cavity (17) as depicted in FIG. 8, wherein activated biofilter media is contained. The water percolates circumferentially and vertically downwards via gravitational feed through the filter media contained within the cavity (17). Water is contained within the inner wall housing (14) and vertical central core (16). The first widening, followed by narrowing of the donut-shaped cavity (17) allows for sufficient retention time for adsorption of iron.

Flow is then redirected inwardly horizontally to the base of the central concave core (16) and enters a plurality of apertures (25) as depicted in FIG. 3. Water then exits the central concave core (16) and enters the outlet nozzle (26) as depicted in FIG. 3. An end-cap (4) with a plurality of fine holes (13), depicted in FIG. 6, only allows water to flow thorough and the retains the biofilter media. When the filter media is exhausted, the end cap (4) can be removed and the media blow-down by washing. The biomaterial can be collected, treated and reused or can be entirely replaced with new media.

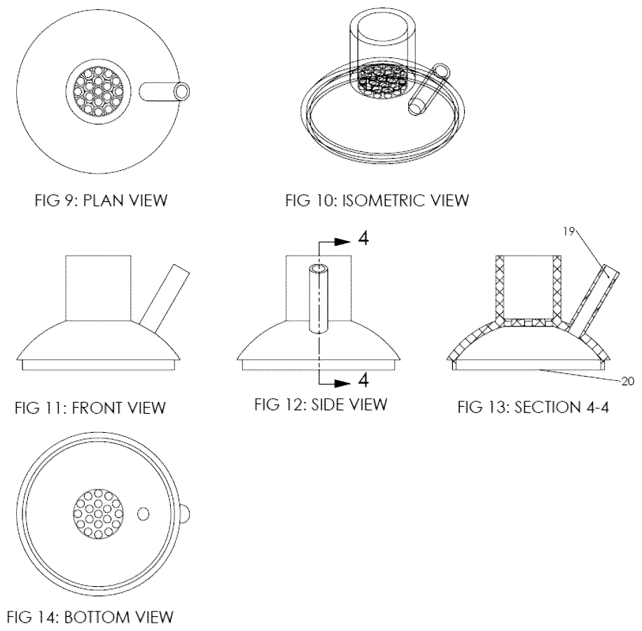

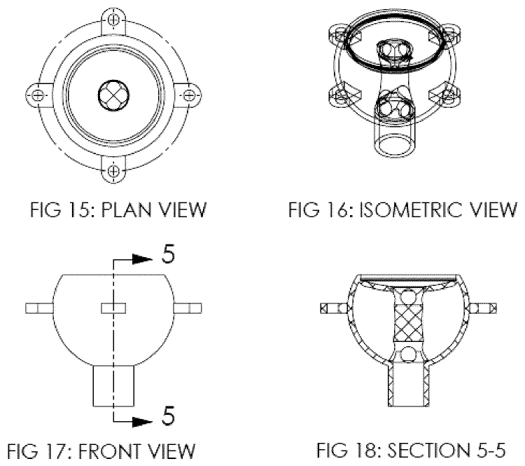

The biofilter housing unit comprises of a housing cover as illustrated in FIGS. 9 to 14. The air inlet nozzle (19) in contained on the housing cover as depicted in FIG. 13. A circular lip (20) allows the cover to be fitted onto the main body of the housing which is illustrated in FIGS. 15 to 18. The housing cover allows for ease of maintenance and replenishing of biofilter media. In addition, lugs (8) are part of the main housing body as depicted in FIG. 5 and contain holes (9). These lugs (8) with holes (9) facilitate transportation and clamping of housing units to structural supports.

1. A biofilter housing system comprising two housing units, coupled together by a T nozzle and fittings, the secondary housing unit being at a lower elevation than the primary housing unit; with each housing unit comprising a housing cover which comprises: a water inlet nozzle, a distributor with a plurality of holes, and an air inlet nozzle with the housing cover coupled to a housing body which comprises: a concave core with a plurality of openings at the top and bottom of the core, vertically oriented openings at the top and bottom of the core, a concaved saucer-shaped top with an opening at the top of the concaved core, an outlet nozzle for effluent, an end cap with a plurality of fine holes and a plurality of lugs circumferentially placed on the outer housing body.

2. The combination as claimed in claim 1 wherein the housing unit is spherically shaped.

3. The combination as claimed in claim 1 wherein the housing unit is made of plastic, metal, ceramic or clay.

4. The combination as claimed in claim 2 wherein the housing cover is dome-shaped.

5. The combination as claimed in claim 3 wherein the vertical openings at the top and bottom of the central core are cup-shaped.

6. The combination as claimed in claim 3 wherein there are a plurality of air inlet nozzles which are circumferentially oriented.

7. A method of coupling the housing cover as claimed in claim 4 wherein the cover is coupled by press fitting, bolting, clamping, hinging or screwing to the main housing body.

8. The combination as claimed in claim 3 wherein there are a plurality of housing units vertically oriented and coupled together.

9. The combination as claimed in claim 3 wherein the top surface of the main housing body is convex.

10. A method of coupling the end cap as claimed in claim 1 wherein the end cap is press-fitted, screwed, bolted or clamped to the exit nozzle of the main housing body.

11. The combination as claimed in claim 3 wherein the vertical central core is convex.

12. The combination as claimed in claim 3 wherein the housing unit is cylindrically shaped.

13. The combination as claimed in claim 3 wherein the housing unit is cuboid.

14. The combination as claimed in claim 13 wherein the upper and lower openings of the central core are square-shaped.
